(19) United States
(12) Patent Application Publication
(10) Pub. No.: US 2020/0122505 A1
(43) Pub. Date: Apr. 23, 2020

(54) ELECTRIC VEHICLE MOVABLE ON MOTORIZED DIRECTIONAL BALLS

(71) Applicant: HYDRA CONSULTING S.R.L., Pinerolo (Torino) (IT)

(72) Inventor: Mauro ZONA, Torino (IT)

(73) Assignee: HYDRA CONSULTING S.R.L., Pinerolo (Torino) (IT)

(21) Appl. No.: 16/654,421

(22) Filed: Oct. 16, 2019

(30) Foreign Application Priority Data
Oct. 22, 2018 (IT) 102018000009654

(51) Int. Cl. B60B 33/08; B60B 33/00; B60G 7/00; B60G 7/02

(52) U.S. Cl. CPC B60B 33/08; B60B 33/0028; B60B 33/0005; B60G 7/02; B60G 7/006

(57) ABSTRACT

An electric vehicle has a structure mounted on balls which are arranged for rolling on the ground, wherein an actuating roller is associated with each ball. The roller-supporting structure is rotatably mounted about a substantially vertical axis within a main supporting structure which is rigidly connected to the ball-supporting member. The main support structure carries a first electric motor for controlling the rotation of the roller-supporting structure about the substantially vertical axis, while the roller-supporting structure carries a second electric motor for controlling the rotation of the roller about its axis.

### FIELD OF THE INVENTION

The present invention relates to an electric vehicle movable on motorized directional balls.

The invention is applicable to any type of vehicle, but is preferably directed at a vehicle that can be used as a motorized chair, as an alternative mode of transport with respect to conventional solutions, and preferably also suitable for being easily transported or for example stored in the boot of a motor-vehicle, so that it can also be used, if desired, as a “tender” or support vehicle, after the vehicle has been parked.

According to its main characteristic, the invention relates to an electric vehicle, including a structure mounted on balls arranged to roll on the ground,

wherein each ball is freely rotatably supported by a ball-supporting member about any axis passing through the centre of the ball,

wherein an actuating roller is associated with each ball, which is in friction contact with and above the ball, and which is rotatably supported about its axis by a roller-supporting structure,

wherein said roller-supporting structure is, in turn, rotatably mounted about a substantially vertical axis within a main supporting structure, which is rigidly connected to said ball-supporting member,

wherein said main supporting structure carries a first electric motor for driving the rotation of said roller-supporting structure about said substantially vertical axis, and

wherein said roller-supporting structure carries a second electric motor for driving the rotation of the roller about its axis,

in such a way that when the second electric motor is actuated, said roller causes, by friction, rotation of the ball about an axis passing through the centre thereof and parallel to the axis of the roller,

whereas when said first electric motor is actuated, said roller is oriented about said vertical axis, so as to vary the rolling direction of the ball.

As can be seen, in the vehicle according to the invention, the aforesaid second electric motor associated with each ball serves to actuate the rolling of the ball on the ground, while the first electric motor associated with the same ball controls the rolling direction of the ball.

In a preferred embodiment, the electric vehicle according to the invention comprises a structure provided with a plurality (preferably three) articulated legs, each having a lower end with which a respective ball is associated. In one example, the main support structure associated with each ball is articulated about a horizontal axis from the lower end of the respective articulated leg.

Still in the case of the aforesaid preferred embodiment, the vehicle structure carries a single seat and is provided with at least one control member which is operatively connected to an electronic controller located on the vehicle, said electronic controller being programmed to control the first electric motors and the second electric motors of all the balls of the vehicle depending on the position and the movement impressed on the aforesaid at least one control member.

In one embodiment example, a first control member is provided in the form of a lever articulated about a transverse axis anteriorly to the seat. The control lever is associated with a detection system of any known type, operatively connected to the electronic controller in such a way that, during use, the position, the direction of movement and/or the speed of movement and/or the acceleration of the movement of the control lever causes the acceleration or deceleration or braking of the vehicle, forward (for example, if the lever is pushed forward) or backward (in the case of the aforesaid example, if the lever is pulled backwards) with respect to the orientation of the seat. In this embodiment the seat is mounted on the vehicle structure so as to be free to perform limited lateral oscillations which are detected by a seat attitude detection system (for example, consisting of an inertial platform) to allow the electronic controller to control steering of the vehicle, by orienting the drive rollers of the balls, according to the lateral inclination imparted by the user to the seat.

In one variant, a single joy-stick control element is provided for controlling both the forward or backward movement and the steering of the vehicle.

However, nothing excludes the possibility of using control elements of any other type.

Still in the case of the preferred embodiment, the articulated legs of the vehicle are also used to house the electric batteries for supplying the electric motors (which can also be housed in the carrying structure of the vehicle).

### BRIEF DESCRIPTION OF THE FIGURES

Further characteristics and advantages of the invention will become apparent from the description that follows with reference to the attached drawings, provided purely by way of non-limiting example, wherein:

FIG. 1 is a perspective view of a preferred embodiment example of the vehicle according to the invention, with the top of the seat removed for clarity,

FIG. 2 is a perspective view of the vehicle of FIG. 1, in which the support structure of the seat has also been removed,

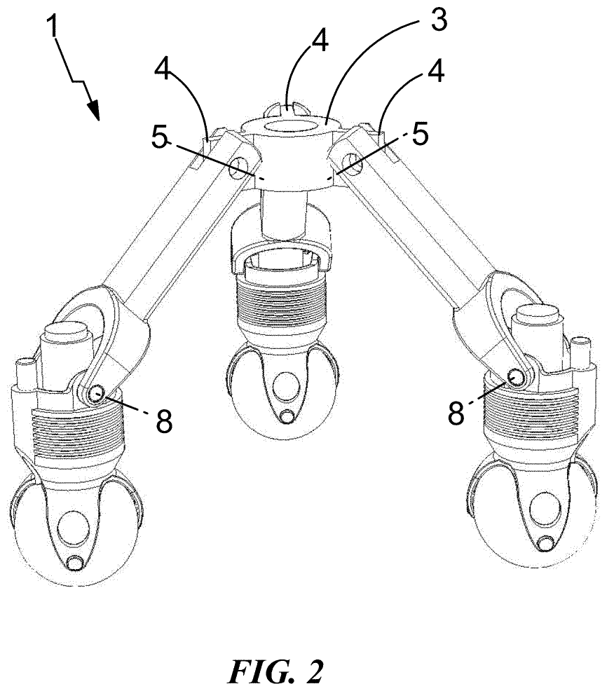

FIG. 3 is a perspective view of an articulated leg of the vehicle of FIG. 1,

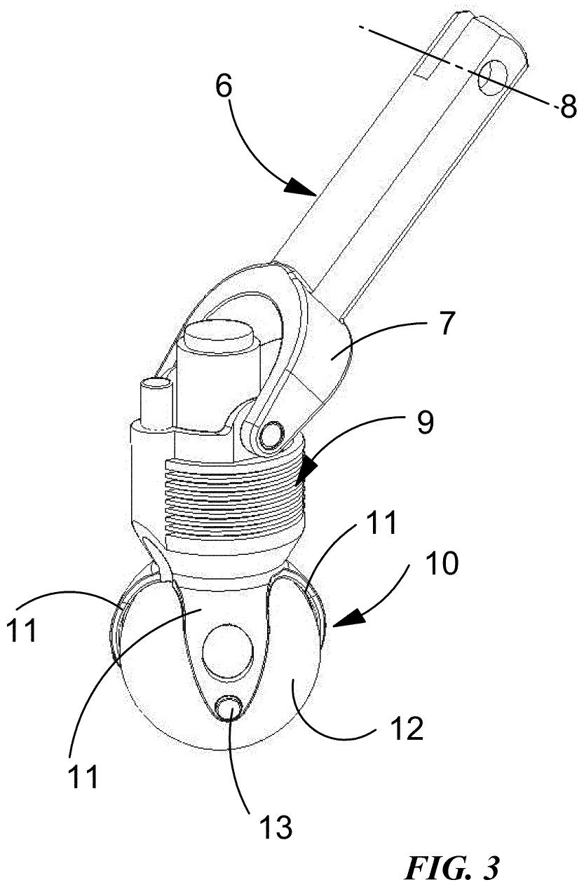

FIG. 4 is a perspective view on an enlarged scale of the assembly including the ball-supporting member and the main supporting structure associated therewith,

FIG. 5 shows the roller-supporting structure, with the relative electric motor for driving rotation of the roller, and the additional electric motor for orienting the aforesaid roller about the vertical axis,

FIG. 6 schematically shows the assembly of a ball and of the relative drive roller.

### DETAILED DESCRIPTION OF THE INVENTION

In the drawings, reference 1 indicates—in its entirety—an electric vehicle movable on motorized directional balls, which is supported and controlled in the manner that will be described in detail below.

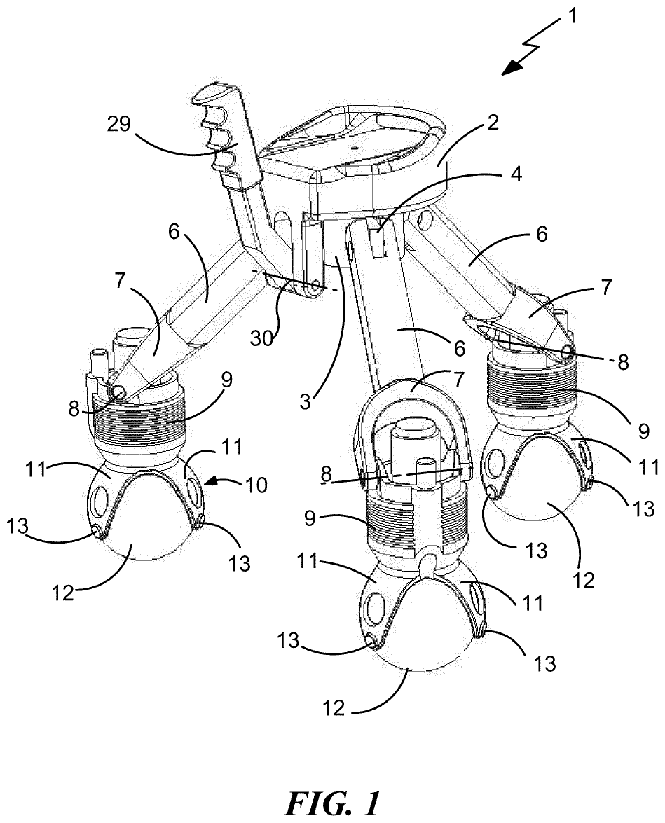

The embodiment illustrated here relates to the application of the invention to the case of a vehicle that can be used as a motorized chair, with a single seat 2, the upper structure of which is not shown in FIG. 1.

The seat 2 is mounted, in a manner that will be described in detail below, on a main support structure 3, which in the example shown is in the form of an annular cylindrical body provided with three ears 4, spaced apart angularly from each other radially from the cylindrical body, on which the upper ends of three articulated legs 6 are mounted in an articulated manner about respective axes 5.

Still with reference to the illustrated example, each articulated leg 6 has a lower end 7 shaped like a fork, connected in an articulated manner about an axis 8 to a main support structure 9 rigidly connected to a ball-supporting member 10.

In the illustrated example, each ball-supporting member 10 comprises a triad of three curved flanges 11 which define a seat for a respective ball 12. The ends of the three flanges 11 terminate below the equatorial plane of the ball 12 and each carry an engagement element 13, for example, in the form of a freely rotating ball or a rounded-shaped foot, for rolling or sliding contact with the ball 12.

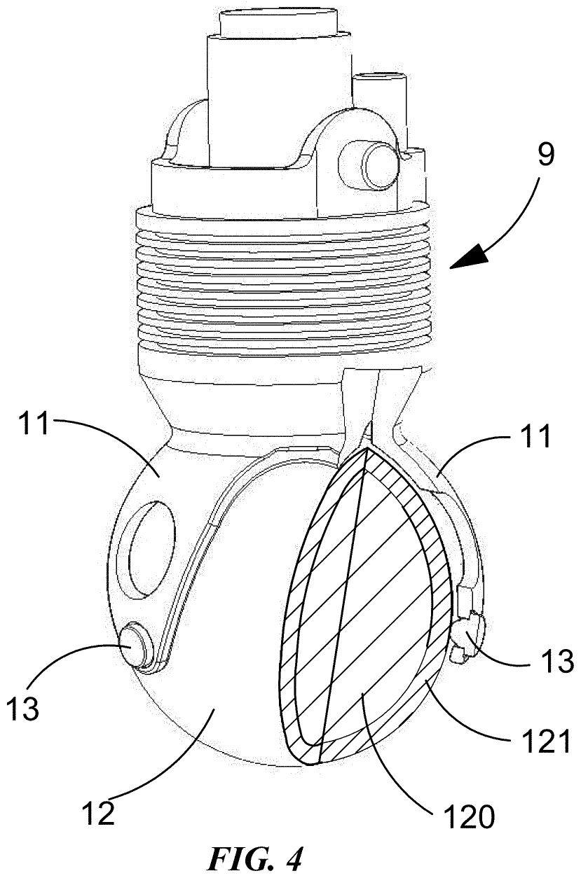

Still according to an embodiment, each ball 12 can have a core of metal material 120 (for example steel) or of composite material reinforced with fibre (for example, carbon fibre) and an outer layer of rubber 121 (of a type similar to that of used for motor-vehicle tires) vulcanized over the core (see FIG. 4).

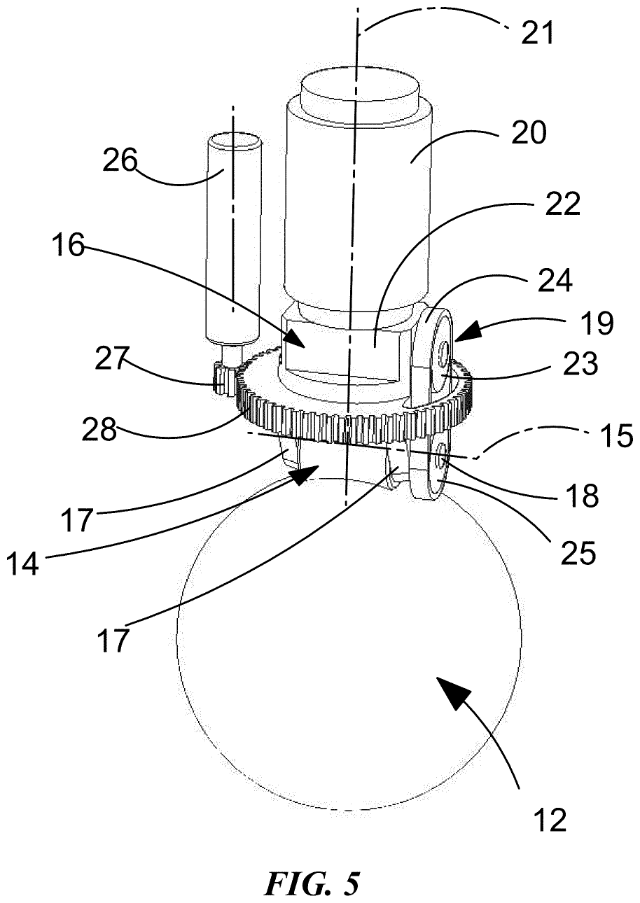

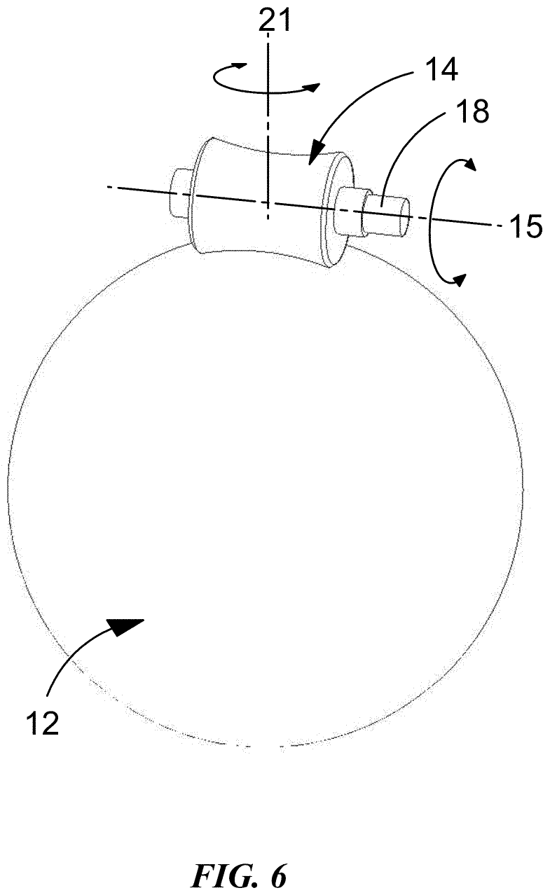

With reference in particular to FIGS. 5 and 6, above each ball 12 is an actuating roller 14, which is rotatably supported about a horizontal axis 15 by a roller-supporting structure 16. The roller-supporting structure 16 includes a pair of flanges 17 located at the two opposite ends of the roller 14, to rotatably support the shaft 18 of the roller. Rotation of the roller 14 is controlled by a transmission 19 by an electric motor 20.

In the illustrated example, the body of the electric motor 20 rises above the roller-supporting structure 11 and is oriented along a vertical axis 21.

The transmission 19, in the case of the illustrated example, includes a pair of bevel gears (not shown) of which the box 22 is visible, which allows transmission from the shaft (not shown) of the electric motor 20 to a pulley 23. The pulley 23 is, for example, a gear pulley in engagement with a toothed belt 24 that transmits the rotation of the pulley 23 to an additional pulley 25 mounted on the shaft 18 of the roller 17.

Of course, the transmission described above is mentioned here by way of example only. The transmission 19 could in fact be made in any other known way, for example by means of a pair of gears.

The entire assembly of the roller-supporting structure 16, with the transmission 19, the electric motor 20, and the roller 14, is rotatably mounted about the vertical axis 21 within a tubular body of the main support structure 9. Moreover, the main support structure 9 carries an electric motor 26 which controls the rotation of the roller-supporting structure 16 about the vertical axis 21, for example, by engaging a pinion 27 mounted on the shaft of the electric motor 26 with a ring gear 28 coaxially mounted on the roller-supporting structure 16. In the illustrated example, the ring gear 28 has a body with a slot through which the belt 24 of the transmission 19 extends.

With reference to FIG. 6, the roller 14 is rotated by the electric motor 20 to cause the ball 12 to roll on the ground due to the frictional contact between the roller 14 and the ball 12.

As can be seen, in the preferred embodiment, the roller 14 has a body tapered from the ends towards the centre, so as to define a circular concave profile outwards, corresponding to the profile of the ball 12. Still in the case of the preferred embodiment, the roller 14 is, for example, composed of a core of metal material (for example, steel) or composite material (for example, carbon fibre) coated with a layer of rubber.

As indicated above, it is evident that activation of the electric motor 20 causes rotation of the roller and the consequent rolling of the ball 12 on the ground. At the same time, activation of the electric motor 26 causes an orientation of the roller 14 about the vertical axis 21, which consequently determines the rolling direction of the ball 12, since, in principle, in every condition the ball 12 rolls by rotating about a horizontal axis parallel to the axis 15 of the roller 14.

Controlling the activation of the electric motors 20, 26 associated with the three balls 12 therefore enables control of the direction of movement, the speed of movement and the acceleration or deceleration of the vehicle 1. By controlling the electric motors 20 that control the drive rollers 14 of the three balls 12 it is possible, in particular, to also control deceleration and/or braking of the vehicle.

In the preferred embodiment, at least one electronic controller that controls the electric motors 20, 26 is provided on board the vehicle to obtain a movement and a direction of movement of the vehicle as a function of the commands given by the user.

For this purpose, in the preferred example shown here, the vehicle comprises a first control member 29 consisting of a control lever articulated to the front part of the seat 2 about a transverse axis 30. The lever 29 is operatively connected to any device able to detect the movement (direction and/or speed and/or acceleration) of the lever 29 and to send a signal to the electronic controller. The electronic controller is programmed in such a way as to cause a forward or backward movement, with an acceleration or a deceleration or even a braking function according to the position of the lever 29, of its direction of movement and/or of its speed of movement and/or its acceleration or deceleration.

Still in the case of the preferred embodiment, the seat structure 2 is mounted on the support structure 3 by any type of elastic suspension that allows the structure 2 to tilt laterally to the right or to the left. In this case as well, the structure of the seat 2 is operatively associated with any known type of device (for example, an inertial platform) configured to detect the attitude of the structure 2 and consequently control the steering of the vehicle by actuation of the electric motors 26 that orientate the ball drive rollers 12 about their respective vertical axes 21.

Therefore, the user can easily and intuitively control the vehicle by acting on the control lever 29 and moving the body laterally to tilt the seat from one side or the other, according to the required direction of movement.

It is of course possible to use any other type of control member, for example, a single joy-stick control member for controlling both forward or backward movements, and vehicle steering.

The electric batteries for supplying electric motors are arranged inside the articulated legs 6 and the vehicle structure.

Of course, the principle underlying the present invention is that of providing a plurality of rolling balls, which are set in rotation by respective actuating rollers positioned above them, with the actuating rollers that can each be oriented about a respective vertical axis crossing the axis of the roller, to vary the rolling direction of the respective ball. This basic principle can, of course, be applied to any vehicle configuration, even those that are very different from the one illustrated herein purely by way of example.

The vehicle configuration described herein lends itself to being used as a motorized chair, as an alternative means of transport to the traditional ones, by able-bodied and disabled people.

In the case of the illustrated example, the articulated legs 6 can be rotated about the axes 5 in a grouped condition of reduced bulk, in which the vehicle can be easily transported or stored in the boot of a motor-vehicle.

Of course, without prejudice to the principle of the invention, the details of construction and the embodiments may vary widely with respect to those described and illustrated purely by way of example, without departing from the scope of the present invention.

1. An electric vehicle, including a structure mounted on balls which are arranged for rolling on the ground,
wherein each ball is freely rotatably supported by a ball-supporting member about any axis passing through the centre of the ball,
wherein an actuating roller is associated with each ball, which is in friction contact with and above the ball and which is rotatably supported about an axis of said roller by a roller-supporting structure,
wherein said roller-supporting structure is rotatably mounted about a substantially vertical axis within a main supporting structure which is rigidly connected to said ball-supporting member,
wherein said main supporting structure carries a first electric motor for driving the rotation of said roller-supporting structure about said substantially vertical axis, and
wherein said roller-supporting structure carries a second electric motor for driving the rotation of the roller about the axis of said roller,
so that when the second electric motor is actuated, said roller causes, by friction, rotation of the ball about an axis passing through a center thereof and parallel to the axis of the roller,
whereas when said first electric motor is actuated, said roller is oriented about said vertical axis, so as to vary a rolling direction of the ball.

2. A vehicle according to claim 1, further comprising a structure provided with a plurality of articulated legs each having a lower end with which a respective ball is associated.

3. An electric vehicle according to claim 2, wherein said main supporting structure is associated with each ball and is pivotally supported about a horizontal axis by a lower end of a respective articulated leg of said structure.

4. An electric vehicle according to claim 1, wherein said structure of the vehicle carries at least one seat.

5. An electric vehicle according to claim 1, further comprising at least one control member which is operatively connected to an electronic controller located on board the vehicle, said electronic controller being programmed for driving the first electric motors and the second electric motors of all the balls of the vehicle, on the basis of the position and/or the movement imparted to said at least one control member.

6. An electric vehicle according to claim 5, wherein the at least one control member comprises a first control member in the form of a lever pivotally mounted on the structure of the vehicle about a transverse axis in front of a seat, said control lever being associated with a system for detecting a movement of the control lever, which is operatively connected to the electronic controller so that, in use, a position, a direction of movement and/or a speed of movement and/or a acceleration or deceleration of the movement of the control lever causes a forward or rearward movement of the vehicle and determines the speed and/or the acceleration or deceleration, or a braking, of the vehicle.

7. An electric vehicle according to claim 6, wherein the seat is mounted on the structure of the vehicle in order to be free to have limited lateral oscillations, so as to be configured to act as a second control member, and
said vehicle comprises a system for detecting the attitude of the seat, which is operatively connected to the electronic controller so that, in use, a rightward or leftward inclination of the seat imparted by the user causes a corresponding rightward or leftward steering of the vehicle.

8. An electric vehicle according to claim 5, wherein the at least one control member comprises a single control member in the form of a joy-stick, for controlling both the forward or rearward movement, and the steering of the vehicle.

9. An electric vehicle according to claim 2, wherein electric supply batteries for said electric motors are housed within said articulated legs.

10. An electric vehicle according to claim 1, wherein each ball comprises a core made of metal material or composite material, coated with a layer of rubber.

11. An electric vehicle according to claim 1, wherein said ball-supporting member comprises a plurality of curved flanges defining a receptacle for the ball and projecting downwardly from said main supporting structure, said curved flanges having lower ends carrying engagement elements configured to engage the ball below an equatorial horizontal plane of the ball.
